(19) United States
(12) Patent Application Publication
(10) Pub. No.: US 2008/0310908 A1
(43) Pub. Date: Dec. 18, 2008

(54) Metered Dispensing Device

(75) Inventors: Antonio Ceccarelli, Woodbridge (CA); Gabriele Ceccarelli, Woodbridge (CA); Goyko Martinovic, Woodbridge (CA)

Correspondence Address: THOMPSON HINE L.L.P.;Intellectual Property Group, P.O. BOX 8801, DAYTON, OH, 45401-8801, US

(73) Assignee: METCON PLASTICS INTERNATIONAL INC., Bolton, Ontario (CA)

(21) Appl. No.: 12/066,131

(22) PCT Filed: Sep. 11, 2006
(86) PCT No.: PCT/CA2006/001495

§ 371 Date: Jul. 17, 2008

(51) Int. Cl. B43K 7/00

(52) U.S. Cl. 401/209

(57) ABSTRACT

A metered liquid dispensing device for dispensing a quantity of liquid from a container. The device includes an applicator and a rotatable metering device. The metering device includes an cavity or chamber and rotates from a first position, wherein the chamber is filled from the container, to a second position, wherein the liquid contents of the chamber flows into the applicator. The applicator may include a roll-on applicator or similar topical applicator. Seals may prevent leakage of liquid from apertures and openings during transitions and while in the first and second positions.

### FIELD OF THE APPLICATION

The present application relates to metered dispensing devices and, in particular, to a dispensing device for dispensing a metered quantity of liquid for use in topical applications.

### BACKGROUND

There are a number of dispensers for liquids and powders that attempt to provide a measured or metered quantity of the liquid or powder. Typical dispensers fit into the neck or mouth of a bottle or other container and feature an elongate tube connected to an inverted cup near the bottom of the container. Example dispensers are shown in U.S. Pat. Nos. 5,323,938 and 6,076,708.

The metered dispensing of liquid products is of particular interest to the pharmaceutical industry, where a user is often supposed to use only a predefined quantity of a pharmaceutical product.

In some cases, liquid pharmaceutical products are packaged with a topical applicator, such as, for example, a roll-on device. The user applies the product to his or her skin using the topical applicator. It is very difficult for the user to monitor the quantity of product dispensed when using a topical applicator like a roll-on device. Accordingly, it would be advantageous to have a device for measuring or metering the quantity of liquid dispensed by such an applicator.

Other industries, including the cosmetics industry, may also benefit from a device that dispenses a predefined quantity of liquid product for topical applications.

### SUMMARY OF THE INVENTION

The present invention provides a metered liquid dispensing device for dispensing a quantity of liquid from a container. The device includes an applicator and a rotatable metering device. The metering device includes an chamber or cavity and rotates from a first position, wherein the chamber is filled from the container, to a second position, wherein the liquid contents of the chamber flows into the applicator. The applicator may include a roll-on applicator or similar topical applicator. Seals may be provided to prevent leakage of liquid from apertures and openings during transitions and while in the first and second positions.

In one aspect, the present application provides a metered liquid dispenser for dispensing a metered quantity of liquid from a container having a mouth. The dispenser includes a plug for sealing the mouth of the container, the plug having a first opening providing fluid communication with the interior of the container, and an applicator for applying the liquid, the applicator including a bottom end and an application device, the bottom end having a second opening providing fluid communication with the application device. It also includes a metering device disposed between the plug and the bottom end of the applicator, the metering device having a top side and a bottom side, and the metering device defines a cavity. The metering device is rotatable between a first position and a second position, and in the first position the cavity is in fluid communication solely with the first opening, and in the second position the cavity is in fluid communication solely with the second opening.

In a further aspect, the present invention provides a metered liquid dispenser for dispensing a metered quantity of liquid from a container having a mouth. The dispenser includes plug means for sealing the mouth of the container and having a fluid outlet, applicator means for applying the liquid, the applicator means including a fluid inlet, and metering means for metering a quantity of liquid, the metering means being disposed between the plug means and the applicator means, the metering means being rotatable about a center axis between a first position and a second position. The metering means includes a dosing means for metering the quantity of liquid received through the fluid outlet, the dosing means being in fluid communication solely with the fluid outlet when in the first position and being in fluid communication solely with the fluid inlet when in the second position.

In yet a further aspect, the present invention provides a metered liquid dispenser for dispensing a metered quantity of liquid from a container having a mouth. The dispenser includes a plug for sealing the mouth of the container, an applicator for applying the liquid, the applicator including a bottom end and an application device, and a metering device disposed between the plug and the bottom end of the applicator, the metering device having a top side and a bottom side, and the metering device defines a cavity. The metering device and the plug define a first passage providing fluid communication between the cavity and the interior of the container, and the metering device and the applicator define a second passage providing fluid communication between the cavity and the application device. The metering device is rotatable between a first position and a second position, and in the first position the cavity is in fluid communication with the first passage and the second passage is occluded, and in the second position the cavity is in fluid communication with the second passage and the first passage is occluded.

In another aspect the present application provides a dispensing device. The dispensing device includes a container having a mouth, a plug for sealing the mouth of the container, the plug having a first opening providing fluid communication with the interior of the container, and an applicator for applying the liquid, the applicator including a bottom end and an application device, the bottom end having a second opening providing fluid communication with the applicator device. It also includes a metering device disposed between the plug and the bottom end of the applicator, the metering device having a top side and a bottom side, and the metering device defines a cavity. The metering device is rotatable between a first position and a second position, and in the first position the cavity is in fluid communication solely with the first opening, and in the second position the cavity is in fluid communication solely with the second opening.

Other aspects and features of the present application will be apparent to those of ordinary skill in the art from a review of the following detailed description when considered in conjunction with the drawings.

### BRIEF DESCRIPTION OF THE DRAWINGS

Reference will now be made, by way of example, to the accompanying drawings which show an embodiment of the present application, and in which:

FIG. 1 shows a perspective view of an embodiment of a metered dispensing device connected to a container;

FIG. 2 shows a cross-sectional view of the metered dispensing device of FIG. 1;

FIG. 3 shows a top perspective view of an embodiment of a metering device;

FIG. 4 shows a top view of the metering device of FIG. 3;

FIG. 5 shows a bottom perspective view of the metering device of FIG. 3;

FIG. 6 shows a bottom view of the metering device of FIG. 3;

FIG. 7 shows a cross-sectional view of an embodiment of a ball housing;

FIG. 8 shows a perspective view of a further embodiment of the metering device;

FIG. 9A shows a cross-sectional view of another embodiment of a dispensing device;

FIG. 9B shows an enlarged view of a portion of the cross-sectional view of FIG. 9A;

FIGS. 10A, 10B, and 10C show a front view, side view, and perspective view, respectively, of the container shown in FIG. 9A;

FIG. 11 shows a perspective view of a bleeder valve from the dispensing device shown in FIG. 9A;

FIGS. 12A, 12B, and 12C show a front view, a cross-sectional view, and a bottom view, respectively, of the applicator shown in FIG. 9A;

FIGS. 13A, 13B, and 13C show a front view, a cross-sectional view, and a top view, respectively, of the plug shown in FIG. 9A;

FIGS. 14A, 14B, and 14C show a side view, cross-sectional view, and bottom view, respectively, of the metering device shown in FIG. 9A; and

FIGS. 15A and 15B show a perspective view and cross-sectional view, respectively, of the cap shown in FIG. 9A.

Similar reference numerals are used in different figures to denote similar components.

### DESCRIPTION OF SPECIFIC EMBODIMENTS

The following description is presented to enable any person skilled in the art to make and use the invention. Various modifications to the specific embodiments will be readily apparent to those skilled in the art, and the generic principles defined herein may be applied to other embodiments and applications without departing from the spirit and scope of the invention. Moreover, in the following description, numerous details are set forth for the purpose of explanation; however, any persons skilled in the art would realize that certain details may be modified or omitted without affecting the operation of the invention. In other instances, well-known structures and devices are not shown or are shown in a simplified form in order not to obscure the description with unnecessary detail.

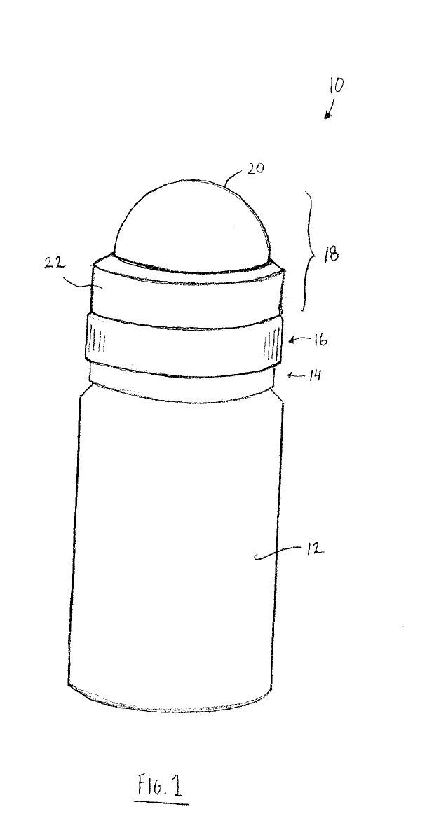

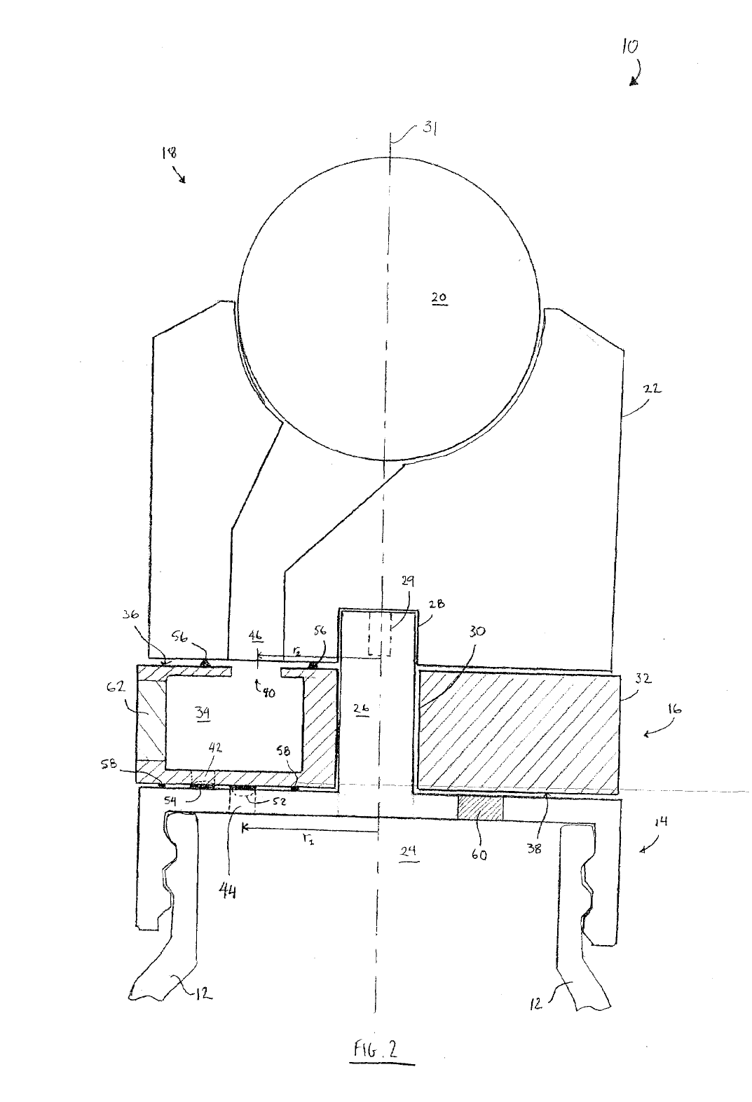

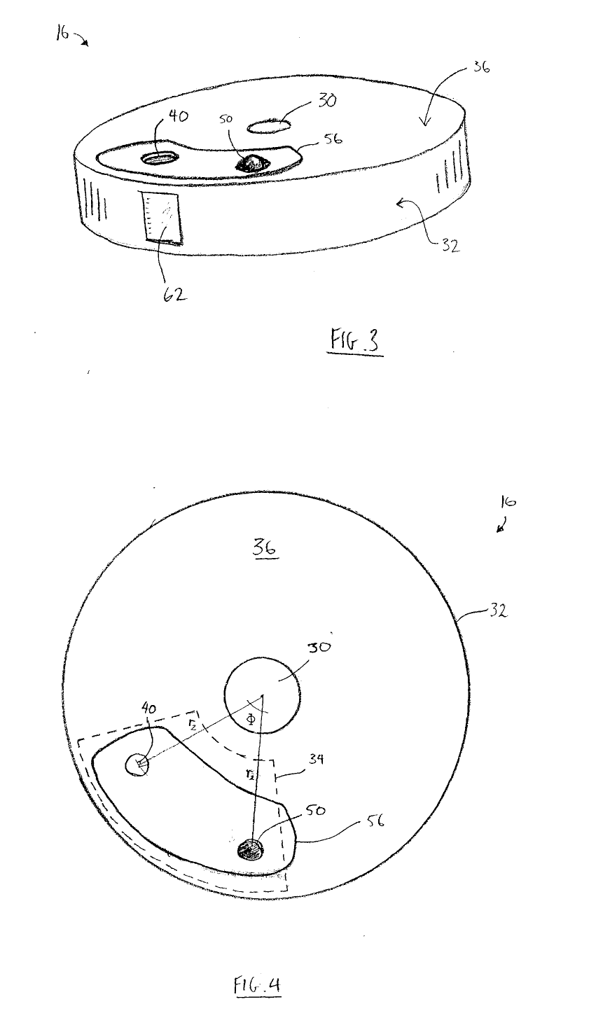

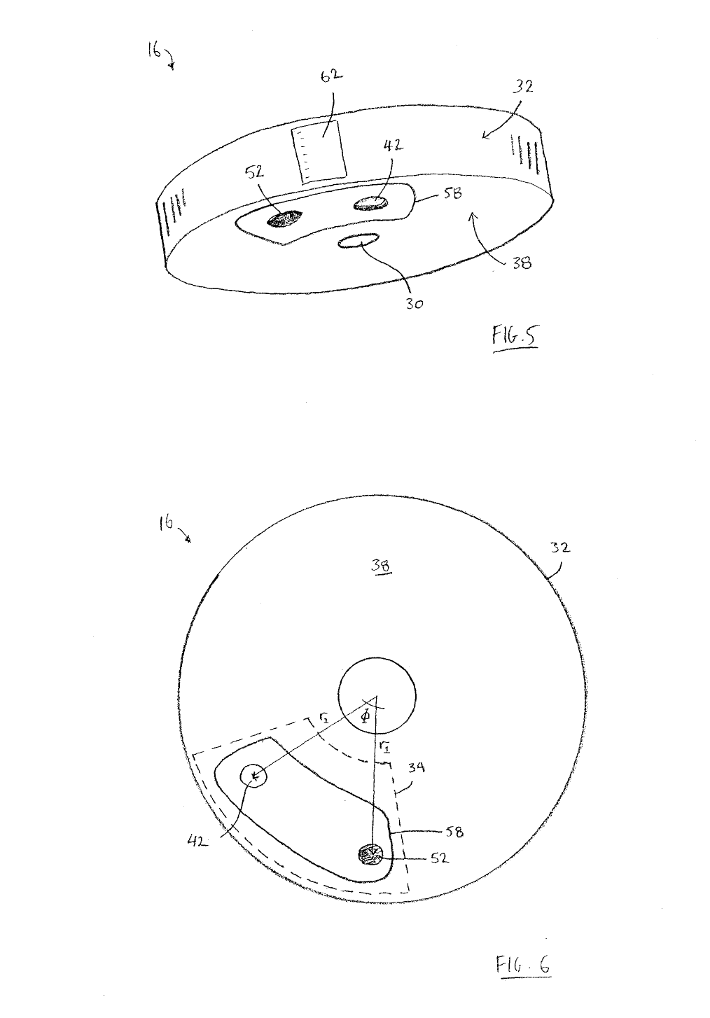

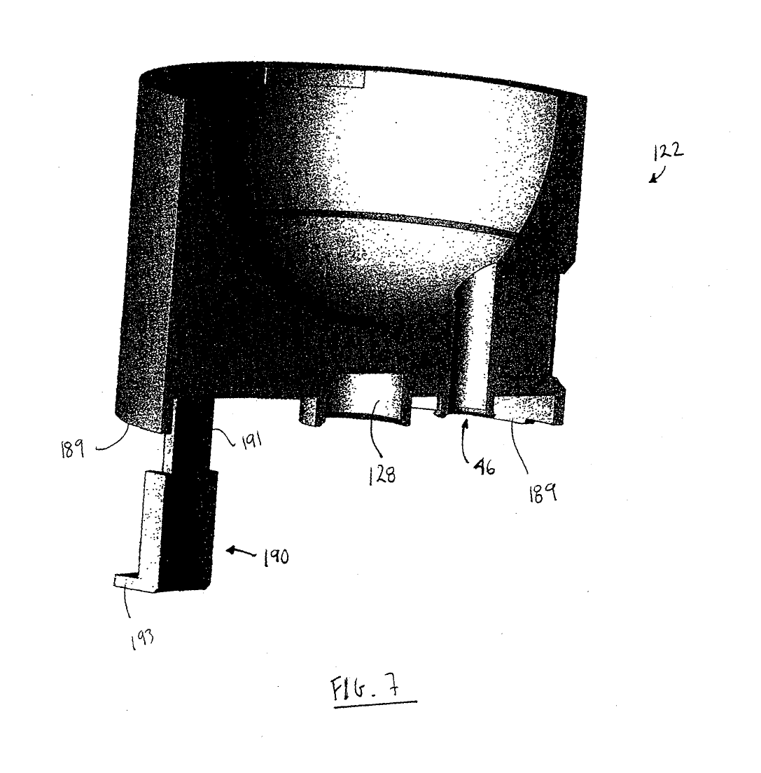

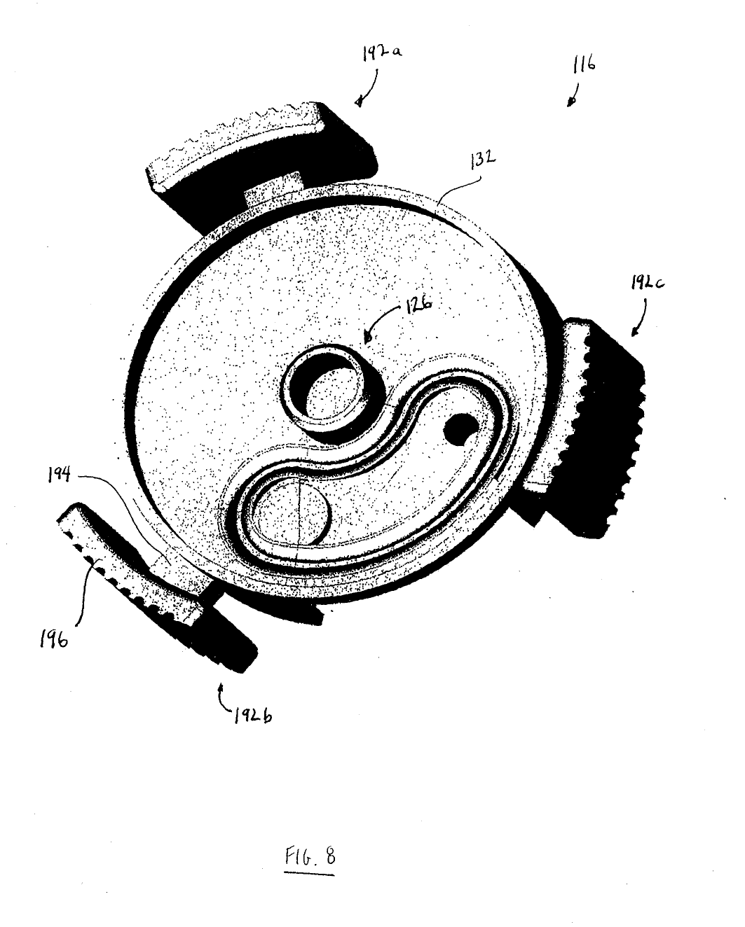

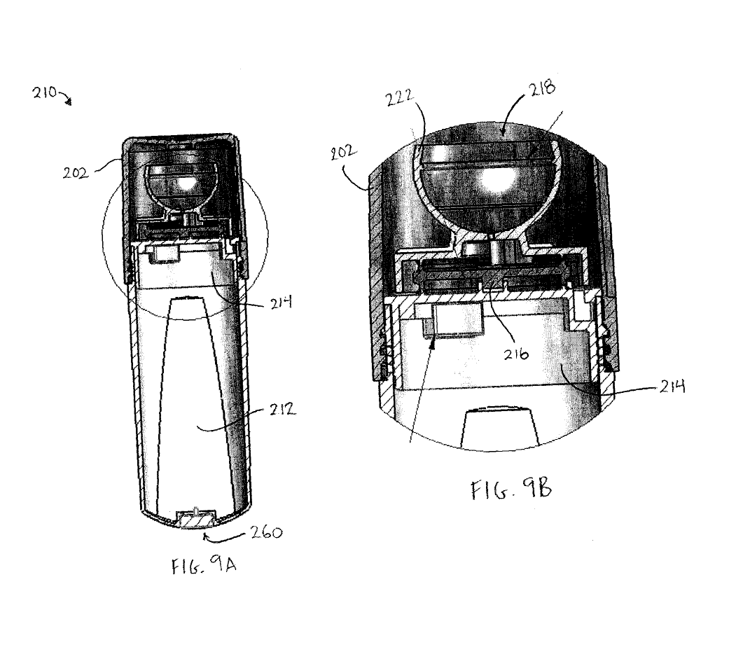

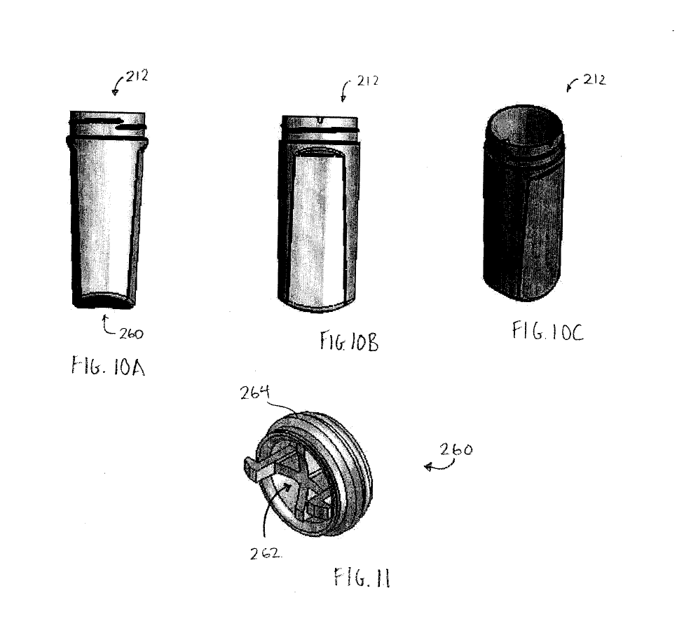

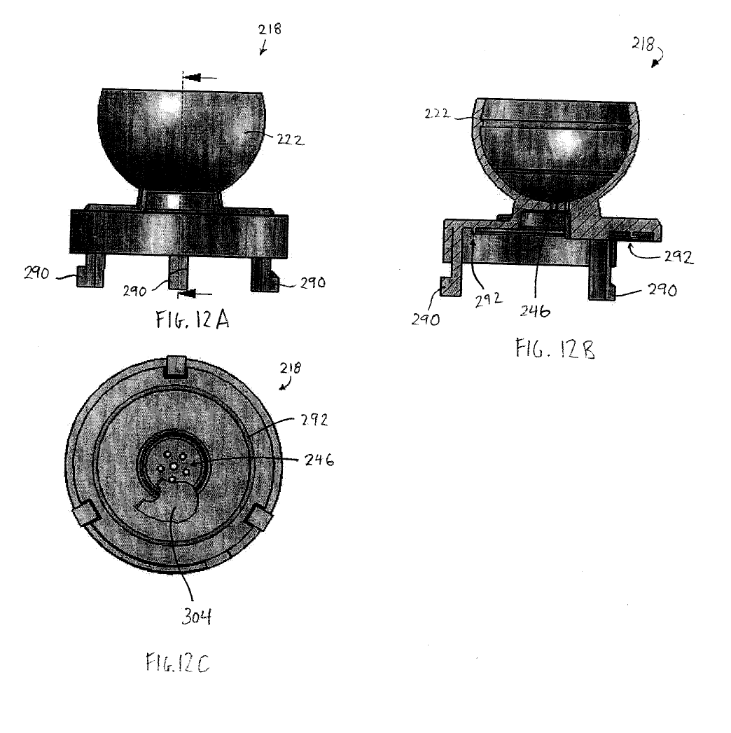

Reference is first made to FIG. 1, which shows a perspective view of an embodiment of a metered dispensing device 10 connected to a container 12. The metered dispensing device 10 is shown in cross-section in FIG. 2.

The metered dispensing device 10 includes a plug 14, a metering device 16, and an applicator 18. In this embodiment, the applicator 18 comprises a roll-on applicator. The roll-on applicator includes a ball housing 22, and a rollerball 20.

The ball housing 22 is shaped with a concave interior to receive and hold the spherical rollerball 20. The concave interior of the ball housing 22 is sized to retain the rollerball 20 within the housing 22 but provide sufficient play for the rollerball 20 to rotate. Liquid in contact with the underside of the rollerball 20 within the housing 22 is drawn out of the housing 22 on the surface of the rollerball 20 as the rollerball 20 is rotated. In this manner, liquid is applied to the skin or other surfaces using the roll-on applicator, as is known in the art. The applicator 18 may have a cover or cap (not shown) for enclosing the rollerball 20 when the device 10 is not in use.

The container 12 includes a mouth opening 24 at its top end. The plug 14 attaches to the top end and seals the mouth opening 24 of the container 12. The attachment of the plug 14 to the container 12 may be by way of mating threads, as shown in FIG. 2. In this embodiment, the plug 14 features interior threads for engaging exterior threads on the top end of the container 12. In another embodiment, the plug 14 may include exterior threads for mating with interior threads on the top end of the container. In other embodiments, the plug 14 may snap fit or friction fit over or into the mouth opening 24 of the container 12. In yet other embodiments, the plug 14 may be welded to the mouth opening of the container 12. Those skilled in the art of packaging will appreciate the range of possible mechanisms for attaching the plug 14 to the container 12. It will be appreciated that in some embodiments the plug 14 may be integrally formed with the container 12.

The metering device 16 is positioned between the plug 14 and the applicator 18.

Reference is now also made to FIGS. 3 and 4, which show a top perspective view and a top view, respectively, of an embodiment of the metering device 16. FIGS. 5 and 6 show a bottom perspective view and a bottom view, respectively, of the embodiment of the metering device 16. The metering device 16 is generally cylindrical and includes an upper surface 36, a lower surface 38, and a knurled side surface 32.

Referring to FIGS. 1 to 6, the plug 14 and the applicator 18 are fixed in position relative to the container 12 when assembled. The metering device 16 is mounted so as to permit it to rotate relative to the plug 14 and the applicator 18 about a center axis 31. In this embodiment, a spindle 26 projects upwards from the plug 14 along the center axis 31. The spindle 26 is attached at its upper end to the applicator 18. In one embodiment, to allow assembly, the applicator 18 includes a cavity 28 centered in its underside for receiving the upper end of the spindle 26. The upper end of the spindle 26 and interior surface of the cavity 28 may have a corresponding key shape that provides for locking engagement of the spindle 26 into the cavity 28 and/or prevents rotation of the applicator 18 relative to the plug 14. For example, one or more projections 29 may be provided on either the spindle 26 or within the cavity 28 and corresponding indentations may be provided to receive the projections 29 in a snap-fit engagement. In another embodiment, the spindle 26 may be glued, welded or otherwise affixed to the cavity 28.

The metering device 16 includes an axial passage 30 through which the spindle 26 passes, allowing the metering device 16 to rotate around the spindle 26.

The metering device 16 includes an interior cavity 34. The interior cavity 34 is designed to have a volume sufficient to provide the desired predetermined metered dosage of liquid. The metering device 16 includes an upper aperture 40 in the upper surface 36, and a lower aperture 42 in the lower surface 38. Both the upper aperture 40 and the lower aperture 42 provide fluid communication with the interior cavity 34.

The plug 14 includes a top opening 44 (shown in dashed lines in FIG. 2). The top opening 44 provides fluid communication with the interior of the container 12. The top opening 44 in the plug 14 is centered a radial distance r₁ from the center axis 31. The lower aperture 42 in the metering device 16 is also centered a radial distance r, from the center axis 31, such that the metering device 16 may be rotated into a position wherein the lower aperture 42 comes into registration with the top opening 44 in the plug 14, thereby providing fluid communication between the interior of the container 12 and the inner chamber 34 of the metering device 16. This rotational position may be termed a first position.

The applicator 18 includes a bottom opening 46 on its underside. The bottom opening 46 provides a fluid inlet to the applicator 18. In this embodiment, the bottom opening 46 provides a fluid inlet to the rollerball 20. The bottom opening 46 is positioned a radial distance r₂ from the center axis 31. The upper aperture 40 in the metering device 16 is also centered a radial distance r₂ from the center axis 31, such that the metering device 16 may be rotated into a position wherein the upper aperture 40 comes into registration with the bottom opening 46 of the applicator 18, thereby providing fluid communication between the inner chamber 34 and the applicator 18. This rotational position may be termed a second position. The first position is a different rotational position from the second position, i.e. the inner chamber 34 is not in fluid communication with both the interior of the container 12 and the applicator 18 at the same time.

The radial distances r₁ and r₂ are not necessarily the same. The dispensing device 10 may be provided with appropriate protrusions, slots, and other mechanical features sufficient to provide a snap fit when the metering device 16 is placed in the first and/or second position and to prevent over rotation.

In operation, the metering device 16 is placed in the first position, such that the inner chamber 34 is in fluid communication with the interior of the container 12 through the top opening 44 and the lower aperture 42. The container 12 and dispensing device 10 are then inverted (i.e. held upside down) and liquid within the container 12 flows into the inner chamber 34. With the container 12 and dispensing device 10 held upside down, the user then rotates the metering device 16 from the first position to the second position, such that the inner chamber 34 is no longer in fluid communication with the container 12. In the second position, the inner chamber 34 is in fluid communication with the applicator 18 through the upper aperture 40 and the bottom opening 46. The liquid within the inner chamber 34 flows through the upper aperture 40 into the applicator 18 and the user applies the liquid using the rollerball 20. In this manner, the user only receives the quantity metered by the volume of the inner chamber 34.

In order to prevent leakage when the metering device 16 is in the first and/or second position, the metering device 16, the plug 14, and/or the applicator 18 may be provided with seals for sealing the apertures 40, 42 and openings 44, 46 when they are not in registration with each other. In particular, the upper surface 36 of the metering device 16 may include a first raised sealing nub 50. The first raised sealing nub 50 is positioned a radial distance r₂ from the center axis 31 and is spaced an angular displacement Φ from the upper aperture 40, wherein the angular displacement Φ is the angular displacement corresponding to a transition between the first position and the second position. When the metering device 16 is in the first position, such that the lower aperture 42 is in communication with the top opening 44 in the plug 14, the first raised sealing nub 50 is in registration with and seals the bottom opening 46. The first raised sealing nub 50 is sized to friction fit into and seal the bottom opening 46 when the metering device 16 is rotated into the first position.

Similarly, the metering device 16 may include a second raised sealing nub 52 on its lower surface 38. The second raised sealing nub 52 is positioned a distance r₁ from the center axis 31 at an angular displacement Φ from the lower aperture 42. When the metering device 16 is rotated into the second position, the second raised sealing nub 52 engages the top opening 44 in the plug 14, thereby sealing it and preventing leakage from the container 12.

Corresponding nubs may be provided for blocking the apertures 40, 42 when not in use. For example, the undersurface of the applicator 18 may feature a third sealing nub (not shown) positioned so as to seal the upper aperture 40 when the metering device 16 is in the first position. The plug 14 may include a fourth sealing nub 54 for sealing the lower aperture 42 when the metering device 16 is in the second position.

The dispensing device 10 may also include wipers for preventing leakage between the metering device 16 and the plug 16 and/or the applicator 18 during transitions between the first position and the second position. For example, an upper wiper 56 may be provided on the upper surface 36 of the metering device 16. The upper wiper 56 may encircle the upper aperture 40 and first raised sealing nub 50. The upper wiper 56 is of sufficient height to bear against the undersurface of the applicator 18 and thereby provide a seal. Similarly, a lower wiper 58 may be provided on the lower surface 36 of the metering device 16. The lower wiper 58 may encircle the lower aperture 42 and second raised sealing nub 52. Those skilled in the art will appreciate that the upper wiper 56 may alternatively be attached to the undersurface of the applicator 18 and/or the lower wiper 58 may be alternatively attached to the top surface of the plug 14.

The wipers 56, 58 and sealing nubs 50, 52, 54 may be constructed of rubber, soft plastics, or other materials suitable for achieving a seal and avoiding excessive friction during rotation of the metering device 16.

In one embodiment, the metering device 16 includes a sight glass 62. The sight glass 62 is a transparent or semi-transparent section of the side surface 32 of the metering device 16 at the location of the inner chamber 34. The sight glass 62 allows the user to directly observe the quantity of liquid in the inner chamber 34. The sight glass 62 may be provided with markings indicating fluid levels and/or fluid volumes within the inner chamber. The sight glass 62 may be constructed of clear plastic, glass, or similar material.

The interior of the applicator 18 may be shaped such that any unused liquid flows back into the inner chamber 34 while the metering device 16 is in the second position, as shown in FIG. 2.

The plug 14 may be provided with a bleeder valve 60 or similar mechanism so as to equalize pressure within the container 12, as will be appreciated by those skilled in the art.

Reference is now made to FIGS. 7 and 8, which relate to a further embodiment of the dispensing device 10. FIG. 7 shows a cross-sectional view of an embodiment of a ball housing 122. FIG. 8 shows a perspective view of an embodiment of a metering device 116.

In this embodiment, the ball housing 122 includes a plurality of downwardly projecting legs 190. In one embodiment, the ball housing 122 includes three such legs 190 (only one is shown in the cross-sectional view of FIG. 7). The legs 190 may includes a thinner upper portion 191 proximate the underside of the ball housing 122. The distal ends of the legs 190 may include an outwardly projecting flange 193. The underside of the ball housing 122 includes a bottom opening 146 and a cavity 128. The underside of the ball housing 122 has a surrounding wall 189 projecting downwards around its perimeter.

The metering device 116 is sized such that its side surface 132 fits within the surrounding wall 189 of the ball housing 122. The metering device 116 includes an upwardly projecting central spindle 126 integrally formed with the metering device 116. The central spindle 126 fits within the cavity 128.

The metering device 116 also includes a plurality of grips 192 (shown individually as 192a, 192b, and 192c). The grips 192 project outwards from the side surface 132. The grips 192 each include an outwardly projecting member 194 attached to the inner curve of an arcuate grip member 196. The outer side of the arcuate grip member 196 may be knurled or grooved.

When assembled, the legs 190 of the ball housing 122 engage the plug (not shown) thereby locking the ball housing 122 and plug into engagement. The metering device 116 sits between the ball housing 122 and the plug and may rotate about its center axis. The legs 190 project downwards along the side surface 132 of the metering device 116. Rotation of the metering device 116 in each direction is limited by the legs 190 abutting against one or more of the outwardly projecting members 194.

Reference is now made to FIGS. 9A and 9B. FIG. 9A shows a cross-sectional view of another embodiment of a dispensing device 210 in accordance with the present application. FIG. 9B shows an enlarged view of a portion of the cross-sectional view of FIG. 9A.

The dispensing device 210 includes a container 212, a plug 214, a metering device 216, and an applicator 218. The applicator 218 includes a ball housing 222 sized to retain a rollerball (not shown). The dispensing device 210 further includes a cap 202. It will be noted that the cap 202 features a relatively flat upper surface while the container 212 features a rounded bottom end, thereby encouraging the user to use and store the dispensing device 210 in the “upside-down” or inverted position—i.e. with the cap 202 on the bottom.

Reference is also now made to FIGS. 10A, 10B, and 10C. These figures show a front view, side view, and perspective view, respectively, of the container 212. The container 212 includes a bleeder valve 260 in its bottom end.

The bleeder valve 260 is shown in greater detail in FIG. 11. The bleeder valve 260 includes a membrane 262 supported by a frame 264. The frame 264 and an aperture in the bottom end of the container 212 are designed to snap-fit together. The bleeder valve 260 ensures proper liquid flow in the dispensing device 210 by equalizing pressure when dispensing liquid from the device 210.

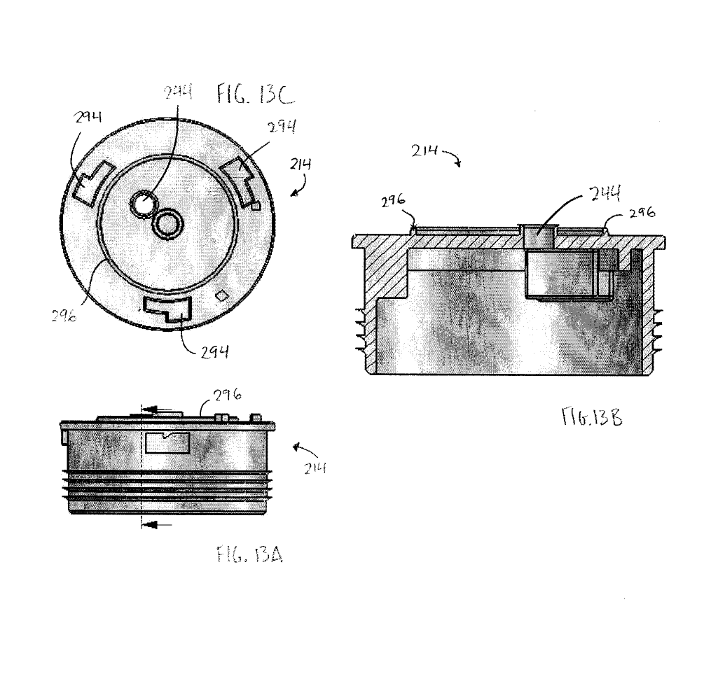

Reference is now made to FIGS. 12A, 12B, and 12C, which show a front view, a cross-sectional view, and a bottom view, respectively, of the applicator 218. Reference is also made to FIGS. 13A, 13B, and 13C, which show a front view, a cross-sectional view, and a top view, respectively, of the plug 214.

The applicator 218 includes downwardly depending legs 290 near its outer edges. The downwardly depending legs 290 are configured to attach the applicator 218 to the plug 214. The plug 214 includes corresponding slots 294 in its upper surface for receiving the downwardly depending legs 290. Once inserted, with a small rotational turn the slots 294 are configured to lock the legs 290 in place.

The applicator 218 includes a bottom opening 246, which in this embodiment includes multiple openings, centered at the bottom of the ball housing 222. The plug 216 includes a top opening 244 in its upper surface, slightly off-center.

The applicator 218 includes an annular ridge 292 on its underside. The plug 214 includes a corresponding annular ridge 296 on its top surface. The annular ridges 292, 296 are designed to fit within circumferential grooves in the metering device 216, as will be described below.

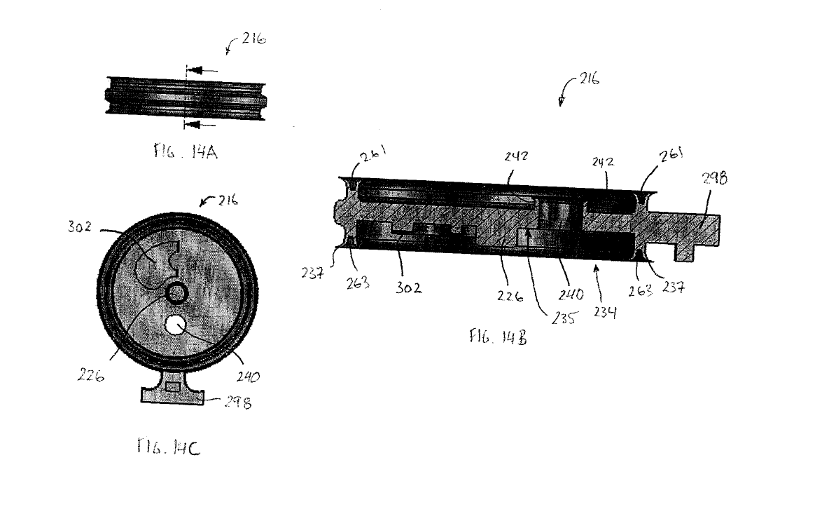

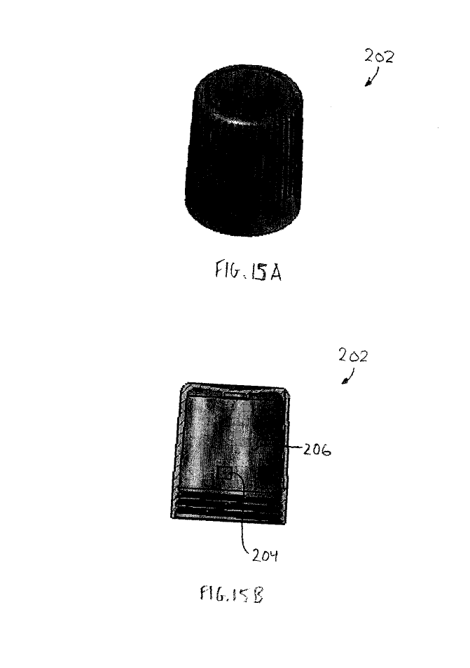

Reference is now also made to FIGS. 14A, 14B, and 14C. These figures show a side view, cross-sectional view, and bottom view, respectively, of the metering device 216. The metering device 216 includes a spindle 226 centered in its bottom side and cooperatively engaging a cavity on the top surface of the plug 214. The metering device 216 also defines an aperture 240 between its bottom side and top side. The aperture 240 provides fluid access through the metering device 216. The aperture 240 is defined by an upwardly extending tube 242.

The metering device 216 includes a downwardly projecting circumferential wall 237. A circumferential groove 263 is formed in the distal end surface of the circumferential wall 237. A corresponding upwardly projecting circumference wall defines a second circumferential groove 261. The circumferential grooves 261, 263 receive the annular ridges 292, 296 of the applicator 218 and plug 214, respectively.

The metering device 216 includes a cavity 234 defined in its bottom side. The cavity 234 is defined in part by the downwardly projecting circumferential wall 237 and a sunken surface 235 of the bottom side. In operation, the bottom of the cavity 234 is defined by the top surface of the plug 214. The dimensions of the cavity 234, together with the dimensions of the tube 242, ensure a consistent predetermined dosage of liquid through the applicator 218.

The metering device 216 is rotatable between a first “closed” position and a second “open” position. The applicator 218 includes a raised seal 304. The raised seal 304 is formed as a raised surface on the underside of the applicator 218. It may be formed from plastic, but it may also include silicon, rubber, or other such materials. It is disposed so as to sealingly stopper the top of the aperture 240 in the metering device 216 when it is in the first “closed” position. The raised seal 304 is disposed so as to sealingly engage the top end of the tube 242. In this position, liquid is prevented from flowing through the metering device 216 into the applicator 218. In this position, liquid is free to flow from the container 212, through the plug 216, and into the cavity 234 in the metering device 216.

The underside or bottom side of the metering device 216 includes a raised seal 302. The seal 302 is a raised surface disposed so as to obscure and close off the top opening 244 in the plug 214 when the metering device 216 is moved into the “open” position. When the metering device 216 rotates from the “closed” position to the “open” position, the top opening 244 in the plug 214 is sealed, thereby preventing any further liquid from entering the metering device 216. At the same time, the aperture 240 is unsealed to allow the liquid accumulated in the cavity 234 to flow into the applicator 218. Accordingly, the liquid that reaches the applicator 218 is limited to the dosage of liquid defined by the dimensions of the cavity 234, including the tube 242.

The metering device 216 may include an outwardly projecting lever 298 that extends beyond the circumference of the applicator 218. The metering device 216 may be rotated between the “closed” and “open” positions using the lever.

Reference is now also made to FIGS. 15A and 15B. These figures show a perspective view and cross-sectional view, respectively, of the cap 202. The cap 202 includes a threaded interior surface designed to engage corresponding threads on the outer surface of the container 212. In other words, the cap 202 is of the screw-on type.

In one embodiment, the cap 202 includes an interior wall 206 that features a mechanism designed to engage the lever 298 during rotational movement of the cap so as to cause the metering device 216 to move between its “open” and “closed” positions. For example, during unscrewing of the cap 202, the mechanism may briefly engage the lever 298 so as to rotate the metering device 216 from the “closed” to “open” position. Similarly, when replacing the cap, the mechanism may briefly engage the lever 298 so as to rotate the metering device 216 back into the “closed” position. In effect, the user need not manipulate the metering device 216 since the rotational screw action of the cap 202 and its mechanism control the transitions of the metering device 216 between positions.

In one embodiment, the mechanism formed on the interior wall 206 of the cap 202 is a protuberance 204 disposed so as to engage a portion of the lever 298 during removal and replacement of the cap 202. Those of ordinary skill in the art will appreciate the range of mechanisms for cooperatively engaging the lever 298 of the metering device 216 during removal and replacement of the cap 202 so as to impart rotational movement between positions of the metering device 216.

Although the foregoing embodiment features the cavity 234 for metering liquid formed in the bottom side of the metering device 216, those skilled in the art will appreciate that other embodiments may provide for the cavity within the top side of the metering device 216. In a further embodiment, the cavity may be formed inside the metering device 216 such that its upper and lower boundaries are provided by the metering device 216 itself. In yet other embodiments, the seals for closing off fluid flow into or out of the cavity when in the “open” or “closed” positions may be differently formed. For example, in an embodiment wherein the cavity is formed in the top surface of the metering device 216, the metering device 216 may provide for a seal to close off the bottom opening 246 in the applicator 218 when in the “closed” position, rather than having the raised seal 304 on the underside of the applicator 218. Similarly, the plug 214 may provide a seal for sealing off fluid communication with the metering device 10 when in the “open” position, instead of having the seal 302 on the underside of the metering device 216. Other variations will be apparent to those of ordinary skill in the art, when considered in light of the present description.

The dispensing device 10 may be constructed of any suitable material, such as polyethylene or the like. Portions of the device 10 may be formed from injection moldable plastics using injection molding. Those skilled in the art will be familiar with suitable materials and manufacturing techniques.

Although the above-described embodiments depict a roll-on applicator, the dispensing device 10 may be implemented using other types of applicators. By way of example, in one embodiment, the applicator may comprise a fixed porous material such as foam. Other types of applicators will be familiar to those of ordinary skill in the art.

The teachings of the present application may be embodied in other specific forms without departing from the spirit or essential characteristics thereof. Certain adaptations and modifications will be obvious to those skilled in the art. The above discussed embodiments are considered to be illustrative and not restrictive.

What is claimed is:

1. A metered liquid dispenser for dispensing a metered quantity of liquid from a container having a mouth, the dispenser comprising:
a plug for sealing the mouth of the container, the plug having a first opening providing fluid communication with the interior of the container;
an applicator for applying the liquid, said applicator including a bottom end and an application device, said bottom end having a second opening providing fluid communication with said application device; and
a metering device disposed between said plug and said bottom end of said applicator, said metering device having a top side and a bottom side, said metering device defining a cavity, and
wherein said metering device is rotatable between a first position and a second position, and wherein in said first position said cavity is in fluid communication solely with said first opening, and wherein in said second position said cavity is in fluid communication solely with said second opening.

2. The metered liquid dispenser claimed in claim 1, wherein said metering device includes a first seal disposed on said lower surface for plugging said first opening when said metering device is in said second position.

3. The metered liquid dispenser claimed in claim 1, wherein said metering device includes an aperture extending between said cavity and said top side, and wherein said applicator includes a second seal disposed on said bottom end for plugging said aperture when said metering device is in said first position.

4. The metered liquid dispenser claimed in claim 1, wherein said metering device comprises a substantially cylindrical body rotatable about a center axis.

5. The metered liquid dispenser claimed in claim 4, wherein said metering device further comprises an outwardly extending lever.

6. The metered liquid dispenser claimed in claim 5, further comprising a screw-on cap having a threaded coupling for connection to the container, the cap having an interior wall including a protuberance disposed to engage said lever and impart rotational force on said lever in the course of screwing and unscrewing said screw-on cap, thereby rotating said metering device between said first and second positions.

7. The metered liquid dispenser claimed in claim 1, wherein said applicator includes a plurality of downwardly depending legs and said plug includes a corresponding plurality of slots for receiving said downwardly depending legs in locking engagement, thereby connecting said plug to said applicator.

8. The metered liquid dispenser claimed in claim 1, wherein said metering device rotates through an angular displacement when transitioning between said first position and said second position.

9. The metered liquid dispenser claimed in claim 1, further including two or more seals for preventing fluid communication between said cavity and said second opening when said metering device is in said first position, and for preventing fluid communication between said cavity and said first opening when said metering device is in said second position.

10. The metered liquid dispenser claimed in claim 1, wherein said applicator comprises a roll-on applicator, said application device comprises a rollerball, and said roll-on applicator further includes a ball housing.

11. The metered liquid dispenser claimed in claim 1, wherein said metering device includes a downwardly depending circumferential wall surrounding a sunken surface, and wherein said cavity is partly defined by said circumferential wall and said sunken surface.

12. A metered liquid dispenser for dispensing a metered quantity of liquid from a container having a mouth, the dispenser comprising:
plug means for sealing the mouth of the container and having a fluid outlet;
applicator means for applying the liquid, said applicator means including a fluid inlet; and
metering means for metering a quantity of liquid, the metering means being disposed between said plug means and said applicator means, said metering means being rotatable about a center axis between a first position and a second position, and wherein said metering means includes a dosing means for metering the quantity of liquid received through said fluid outlet, said dosing means being in fluid communication solely with said fluid outlet when in said first position and being in fluid communication solely with said fluid inlet when in said second position.

13. The metered liquid dispenser claimed in claim 12, further including first sealing means for plugging said fluid outlet when said metering means is in said second position, and second sealing means for plugging said fluid inlet when said metering means is in said first position.

14. The metered liquid dispenser claimed in claim 12, further including a screw-on cap having an interior wall including means to cooperatively engage said metering means to cause said metering means to rotate from said first position to said second position during screw-off removal of said cap and to rotate from said second position to said first position during screw-on replacement of said cap.

15. The metered liquid dispenser claimed in claim 12, wherein said applicator means comprises a roll-on means for applying topical substances.

16. A metered liquid dispenser for dispensing a metered quantity of liquid from a container having a mouth, the dispenser comprising:
a plug for sealing the mouth of the container;
an applicator for applying the liquid, said applicator including a bottom end and an application device; and
a metering device disposed between said plug and said bottom end of said applicator, said metering device having a top side and a bottom side, said metering device defining a cavity,
wherein said metering device and said plug define a first passage providing fluid communication between said cavity and the interior of said container, and wherein said metering device and said applicator define a second passage providing fluid communication between said cavity and said application device,
and wherein said metering device is rotatable between a first position and a second position, and wherein in said first position said cavity is in fluid communication with said first passage and said second passage is occluded, and wherein in said second position said cavity is in fluid communication with said second passage and said first passage is occluded.

17. The metered liquid dispenser claimed in claim 16, wherein said metering device includes a downwardly depending circumferential wall surrounding a sunken surface, and wherein said cavity is defined by said circumferential wall and said sunken surface, the metering device further including an aperture in said sunken surface providing fluid communication between said cavity and said top side, and wherein said first passage includes a first opening in said plug, and said sunken surface further includes a raised seal disposed to occlude said first opening when said metering device is in said second position, and wherein said second passage includes a tubular structure defining said aperture, and said bottom end of said applicator includes a second seal disposed to occlude said tubular structure when said metering device is in said first position.

18. The metered liquid dispenser claimed in claim 16, further comprising a screw-on cap having a threaded coupling for connection to the container, the cap having an interior wall including a protuberance disposed to engage said metering device and impart rotational force on said lever in the course of screwing and unscrewing said screw-on cap, thereby transitioning said metering device between said first and second positions.

19. A dispensing device, comprising:
a container having a mouth
a plug for sealing the mouth of the container, the plug having a first opening providing fluid communication with the interior of the container;
an applicator for applying the liquid, said applicator including a bottom end and an application device, said bottom end having a second opening providing fluid communication with said applicator device; and
a metering device disposed between said plug and said bottom end of said applicator, said metering device having a top side and a bottom side, said metering device defining a cavity, and
wherein said metering device is rotatable between a first position and a second position, and wherein in said first position said cavity is in fluid communication solely with said first opening, and wherein in said second position said cavity is in fluid communication solely with said second opening.

20. The dispensing device claimed in claim 19, wherein said container includes a distal end, and wherein said container further comprises a bleeder valve disposed in said distal end.
